(19) United States
(12) Patent Application Publication
(10) Pub. No.: US 2023/0241856 A1
(43) Pub. Date: Aug. 3, 2023

(54) SYSTEM FOR DESTACKING CARTON BLANKS

(71) Applicant: MULTIVAC SEPP HAGGENMUELLER SE & CO. KG, Wolfertschwenden (DE)

(72) Inventors: Dominik PATZ, Kempten (DE); Philipp ADERMANN, Kempten (DE)

(73) Assignee: MULTIVAC SEPP HAGGENMUELLER SE & CO. KG, Wolfertschwenden (DE)

(21) Appl. No.: 18/104,457

(22) Filed: Feb. 1, 2023

(30) Foreign Application Priority Data
Feb. 1, 2022 (DE) 102022102305.2

(51) Int. Cl. B31B 50/06; B31B 50/07; B31B 50/59

(52) U.S. Cl. CPC B31B 50/062; B31B 50/07; B31B 50/592

(57) ABSTRACT

A system for destacking carton blanks comprises a stacking magazine for receiving a stack of carton blanks, the stacking magazine having a retaining system. The system for destacking carton blanks further comprises a first die comprising a first cavity for shaping the carton blanks, and a transport device with at least one first gripping unit for gripping and displacing carton blanks. The transport device is configured to grip a carton blank from the stack, transport the carton blank into the first cavity and form the carton blank by exerting a force.

### CROSS-REFERENCE TO RELATED APPLICATIONS

This application claims foreign priority benefits under 35 U.S.C. § 119(a)-(d) to German patent application number DE 10 2022 102 305.2, filed Feb. 1, 2022, which is incorporated by reference in its entirety.

### TECHNICAL FIELD

The present disclosure relates to a system for destacking carton blanks, a deep-drawing packaging machine or tray sealing machine comprising a system for destacking carton blanks and a method for destacking carton blanks.

### BACKGROUND

A deep-drawing packaging machine is known from DE 10 2017 121 438 A1. A tray sealing machine is known from DE 10 2012 001 817 A1.

Usually, for the production of packaging trays with a cardboard tray, unfolded carton blanks are destacked by a stacking device, folded in a die by a movement for pressing in and fed to a packaging machine, i.e., a deep-drawing packaging machine, or a tray sealing machine. However, these steps are complex and require several workstations.

### SUMMARY

An object of the disclosure is to provide an improved system for destacking carton blanks and a method for destacking carton blanks.

The system for destacking carton blanks according to the disclosure comprises a stacking magazine for receiving a stack of carton blanks, the stacking magazine having a retaining system or retention system, at least one first die comprising a first cavity for shaping the carton blanks, and a transport device with at least one gripping unit for gripping and displacing carton blanks, wherein the transport device is configured to grip at least one carton blank from the stack, transport the carton blank into the first cavity and form the carton blank by exerting a force. This system enables separating the carton blanks of a stack of carton blanks in a workstation and to give them a specific (especially 3-dimensional, erected) shape. For the purposes of the disclosure, “forming” or “shaping” means at least partial and at least sectional erection of a carton blank.

It is also possible to separate the carton blanks of a stack of carton blanks in a work station and to give them a certain shape and to fix them in a transport system of a packaging machine, e.g., a deep-drawing packaging machine or a tray sealing machine. The retaining system may have retaining plates configured vertically with respect to lateral stacking magazine supports to retain the carton blanks in the stacking magazine. The first die may be disposed underneath the stacking magazine. The die may have at least one suction unit, whereby the carton blank formed in the die remains fixed until a further transfer into the cavity of the die. The die may have several, e.g., two to four, suction units. The transport unit may have several, e.g., two to four, gripping units. The die may have several cavities arranged next to each other. The die may be integrated into a transport system. The conveyor belt may be a feed belt with protruding forming plates.

Advantageously, the transport device is configured to grip the carton blank by suction and pull it into the first cavity. The gripping units of the transport device may be provided with at least one suction unit.

The first die comprises at least one first passage opening, wherein the transport device is configured to move a portion of the first gripping unit through the first passage opening. This allows the carton blanks to be transported in a substantially vertical path of movement between a stacking position in the stacking magazine and a depositing position in the first cavity of the die. The first die may have, e.g., 2 to 4 passage openings.

In a particularly advantageous embodiment, the transport device is configured to apply pressure to the carton blank from above and to press the carton blank into the first cavity. In this embodiment, a passage opening in the die is not necessary.

In this embodiment, it is particularly advantageous to provide a distance between the die and the stacking magazine that is at least 20 cm, preferably 20 cm to 100 cm. The transport device may have a robot arm to grip the carton blanks one by one, turn them over and press them into the first cavity. The robot arm may include a suction unit to grip the carton blanks.

Preferably, the system comprises a second die for shaping carton blanks, the second die comprising an opening, wherein the transport device is configured to transport the carton blank from the stack through the second die into the first cavity. This allows the carton blanks to be pre-formed first by the second cavity and the preformed carton blanks can be pulled further into the first cavity to obtain their final shape. This two-stage shaping simplifies and improves alignment of the side walls of the carton blanks. The second die may have several, e.g., two to four, passage openings.

Preferably, the second die is arranged below the stacking magazine. It is also possible to place the second die above the stacking magazine.

It is advantageous if an upper opening width of the second die is larger than an upper opening width of the first cavity. The upper opening width may correspond to a distance between two lateral supports of the stacking magazine for holding flat carton blanks. It is also possible that a lower opening width of the second die is smaller than the upper opening width of the first cavity in order to receive a carton blank preformed in the second die more easily in the first cavity.

Advantageously the first cavity is provided with a first bottom surface and side walls, the side walls of the first cavity having a first angle of inclination in relation to the first bottom surface, wherein the second die has inclined side walls, the inclined side walls of the second die having a second angle of inclination in relation to the opening which is less than the first angle of inclination. As a result, the carton blanks are first laterally erected in the second die, which simplifies the subsequent insertion of these preformed carton blanks in the first cavity and facilitates the final shaping.

The disclosure further relates to a deep-drawing packaging machine comprising a system for destacking carton blanks according to any of the variants described above. The deep-drawing packaging machine may be provided for the production of packagings with folded carton blanks, which are lined on the inside with a film in order to be able to package food gas-tight and with a long shelf life. The system for destacking carton blanks may be disposed upstream of the forming station of the deep-drawing packaging machine. The carton blanks formed or folded in the system for destacking carton blanks may be manually loaded into a transport system or feed belt, wherein the transport system feeds the formed carton blanks to the forming station to be manually or automatically loaded into the bottom parts of the forming die. The formed or folded carton blanks may be fixed directly in a transport system or feed belt of the deep-drawing packaging machine, wherein the transport system feeds the formed carton blanks to the forming station to be inserted manually or automatically into the bottom parts of the forming die. The transport system of the deep-drawing packaging machine may be integrally configured with the first die of the system for destacking carton blanks, i.e., the first die may be part of the transport system of the deep-drawing packaging machine.

The disclosure further relates to a tray sealing machine comprising the system for destacking carton blanks according to any of the variants described above. The tray sealing machine may be equipped with a sealing device. The sealing device may comprise a rigid die top part which maintains its position during the sealing process. The sealing device may further comprise a movable tray receptacle provided for receiving a tray. The tray, comprising a product, may be guided into the sealing device by a conveyor belt. In a predetermined position in the sealing device, the tray may be gripped by the tray receptable and displaced upwards by it against the upper part of the die. The tray may be sealed with a lidding film which is passed through the sealing device. The trays may be carton blanks. The system for destacking carton blanks of the sealing tray machine may be disposed in front of the tray receiving station. The formed or folded carton blanks may be fixed directly in a transport system or feed belt, wherein the transport system feeds the formed carton blanks to the tray receiving station.

The disclosure further relates to a method for destacking carton blanks, comprising the following method steps: receiving a stack of carton blanks in a stacking magazine, the stacking magazine having a retaining system or retention system, providing at least a first die comprising a first cavity for shaping carton blanks, gripping at least one carton blank by a transport device with at least one gripping unit, transporting the carton blank by means of the transport device from the stack into the first cavity, and forming the carton blank in the first cavity while exerting a force on the carton blank by means of the transport device. This system enables separating the carton blanks of a stack of carton blanks in a workstation and shaping them. It is also possible to separate the carton blanks of a stack of carton blanks in a work station and to give them a certain shape and to fix them in a transport system of a packaging machine, e.g., a deep-drawing packaging machine or a tray sealing machine.

Advantageously, the carton blank is hold from below by the gripping unit through suction and drawn into the first cavity. This allows the carton blanks to be transported in a vertical path of movement between a stacking position in the stacking magazine and a depositing position in the first cavity of the die. The first die may have a first passage opening. A section of the gripping unit may be moved through the first passage opening. The gripping units of the transport device may have at least one suction unit.

Advantageously, pressure is exerted on the carton blank by the gripping unit from above and the carton blank is pressed into the first cavity. In this embodiment, a passage opening in the die is not necessary. In this embodiment, it is particularly advantageous to provide a distance between the die and the stacking magazine that is at least 20 cm, preferably 20 cm to 100 cm. The transport device may have a robot arm to grip the carton blanks one by one, turn them over and press them into the first cavity. The robot arm may comprise a suction unit.

Advantageously, the carton blank is transported from the stack first into a second die and then into the first cavity of the first die. This allows the carton blanks to be preformed first by the second die (i.e., partially erected) and the preformed carton blanks can be pulled further into the first cavity to obtain its fully erected final shape. This two-stage forming simplifies and improves erection of the side walls of the carton blanks. A section of the gripping unit may be moved through a passage opening.

Preferably, the second die is arranged below the stacking magazine. It is also possible to place the second die above the stacking magazine.

It is advantageous if an upper opening width of the second die is larger than an upper opening width of the first cavity. The upper opening width may correspond to a distance between two lateral supports of the stacking magazine for holding flat carton blanks. It is also possible that a lower opening width of the second die is smaller than the upper opening width of the first cavity in order to receive a carton blank preformed in the second die more easily in the first cavity.

All features disclosed in connection with the system for destacking carton blanks may be used individually or together in the method for destacking carton blanks. All features disclosed in connection with the method for destacking carton blanks may be used individually or together in the system for destacking carton blanks.

### BRIEF DESCRIPTION OF THE DRAWINGS

An embodiment according to the disclosure is shown by the following figures, in which:

FIG. 1 is a perspective view of the system for destacking carton blanks according to the disclosure;

FIG. 2 is a schematic partial side view of the first die and the second die;

FIG. 3 is a schematic side view of the system;

FIG. 4 is a schematic side view of the system;

FIG. 5 is a schematic side view of a deep-drawing packaging machine comprising the system for destacking carton blanks; and

FIG. 6 is a schematic perspective view of a tray sealing machine comprising the system for destacking carton blanks.

### DETAILED DESCRIPTION

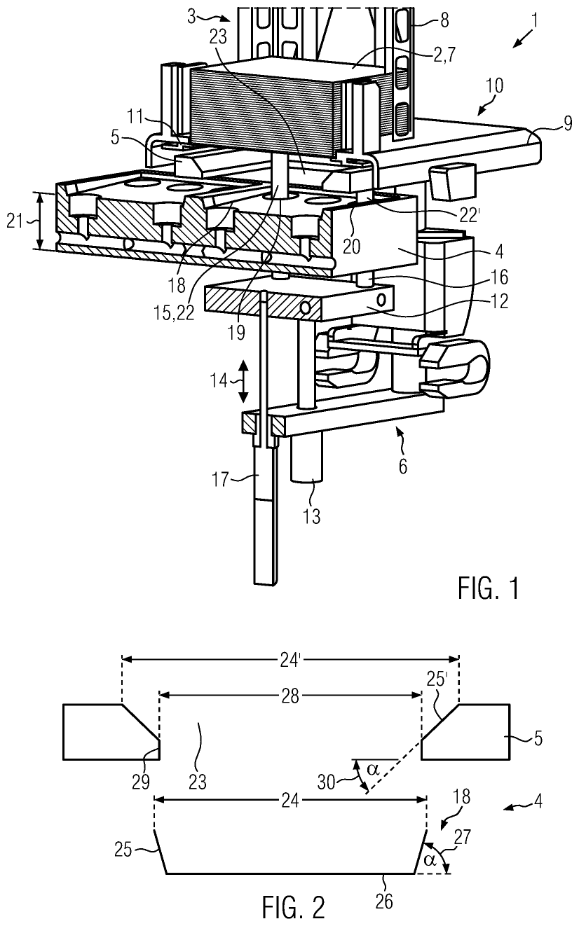

FIG. 1 shows the system 1 for destacking carton blanks 2 according to the disclosure. The system 1 is provided with a stacking magazine 3, a first die 4, a second die 5 and a transport device 6.

The stacking magazine 3 is provided with lateral vertical supports 8 for receiving a stack 7 of carton blanks 2. The supports 8 extend from a base frame 9 of a restraint system or retention system 10 of the system 1. The base frame 9 is provided with one or more substantially horizontal holding elements 11 (e.g., one or more laterally extending projections, such as ledges, plates, or support frames) to hold the carton blanks 2 in the stacking magazine 3. The holding elements 11 partially cover the carton blanks 2 from below.

The transport device 6 is fixed to the base frame 9 of the stacking magazine 3. The transport device 6 is provided with a substantially horizontal plate 12 which may be moved back and forth along a first vertical axis 14 by a lifting device 13 (e.g., electric or pneumatic actuator) of the transport device 6. A first gripping unit 15 and a second gripping unit 16 are disposed on the plate 12. The gripping units 15, 16 comprise suction cups (not shown) which communicate with a vacuum pump (not shown) through a first pipe 17.

The first die 4 comprises a first cavity 18 for shaping (i.e., erecting) the carton blanks 2. A first passage opening 19 and a second passage opening 20 are provided in the first die 4. The first and second passage openings 19, 20 extend along a depth 21 of the first die 4. A portion 22 of a first gripping unit 15 of the transport device 6 is movable through the first passage opening 19 and a portion 22′ of a second gripping unit 16 of the transport device 6 is movable through the second passage opening 20.

The second die 5 is attached to the base frame 9.

FIG. 2 shows a schematic partial view of the first die 4 and the second die 5. The first die 4 is provided with an upper opening width 24, side walls 25 and a bottom surface 26. The side walls 25 of the first cavity 18 have a first angle of inclination 27 with respect to the first bottom surface 26. The second die 5 comprises an opening 23 with an upper opening width 24′ and a lower opening width 28. The second die 5 comprises inclined sidewalls 25′ and straight sidewalls 29, the inclined sidewalls 25′ having a second inclination angle 30 in relation to the lower opening width 28. The upper opening width 24′ of the second die 5 is larger than the upper opening width 24 of the first cavity 18. The lower opening width 28 of the second die 5 is smaller than the upper opening width 24 of the first cavity 18. The second inclination angle 30 may be smaller than the first inclination angle 27.

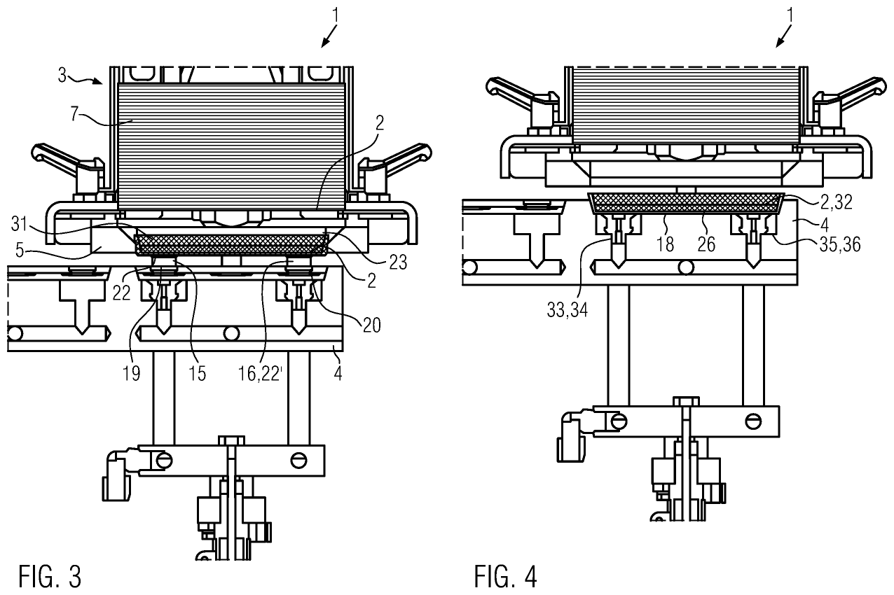

FIG. 3 shows a schematic side view of system 1. To draw a carton blank 2 from the stack 7 into the opening 23 of the second die 5 and preform it, the portion 22 of the first gripping unit 15 is moved through the first passage opening 19 of the first die 4 and the portion 22′ of the second gripping unit 16 is moved through the second passage opening 20 of the first die 4. The bottom carton blank 2 in the stacking magazine 3 is gripped from below by suction. This carton blank 2 is drawn into the opening 23 of the second die 5 and preformed (i.e., partially erected) by the side walls 25′ of the second die 5. In FIG. 3, the carton blank 2 is shown in the opening 23 of the second die 5 in its preformed state 31.

FIG. 4 shows a schematic side view of system 1. The carton blank 2 shown in FIG. 3, preformed in the opening 23 of the second die 5, is drawn into the first cavity 18 of the first die 4 and formed here into a final shape 32, e.g., a tray shape. The first die 4 further comprises a first suction cup opening 33 with a first suction cup 34 and a second suction cup opening 35 with a second suction cup 36 connected to a vacuum unit not shown. When the carton blank 2 is in contact with a bottom surface 26 of the first cavity 18, this carton blank 2 is fixed there by means of the first suction cups 34 and second suction cups 36 and the vacuum of the gripping units 15,16 is switched off. The carton blanks 2 formed, folded or erected in the first cavity 18 will remain fixed in the first die 4 until a further transfer.

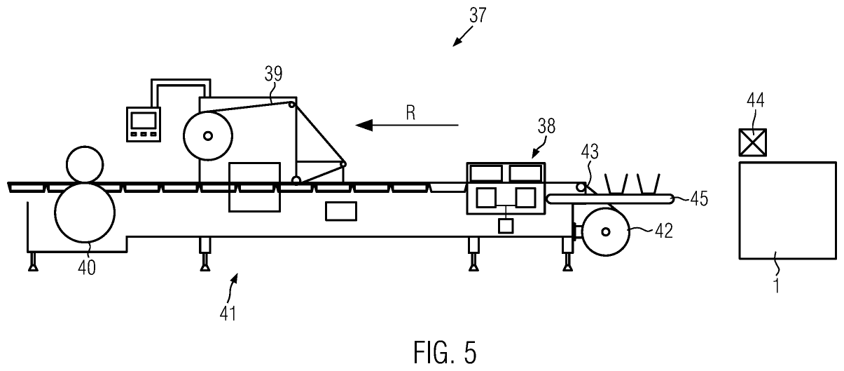

FIG. 5 schematically shows a deep-drawing packaging machine 37 comprising the system 1 for destacking carton blanks 2 with the features set out above. The deep-drawing packaging machine 37 is provided with a forming station 38, a sealing station 39 and a cutting station 40, which are arranged in this order in a working direction R on a machine frame 41. On the input side, there is a feed roller 42 on the machine frame 41, from which a first film web 43 is drawn off. The carton blanks 2 formed in the system 1 are each removed from the first die 4 by means of a manipulator 44 and fed to a feed belt 45 arranged on the deep-drawing packaging machine 37 and inserted into the forming station 38, in which a film is formed into the formed carton blanks 2.

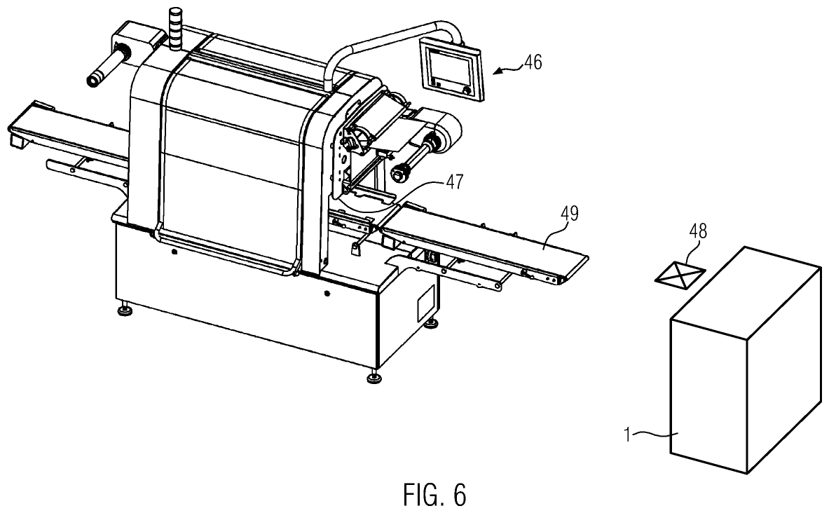

FIG. 6 schematically shows a tray sealing machine 46 comprising the system 1 for destacking carton blanks 2. The tray sealing machine 46 is provided with a sealing station 47 for sealing trays with a lidding film. The sealing station 47 is provided with a die top part and a tray receptacle (not shown). The carton blanks 2 formed in the system 1 are each removed from the first die 4 by means of a manipulator 48 and fed to a feed belt 49 arranged on the tray sealing machine 46.

What is claimed is:

1. A system for destacking carton blanks, comprising:
a stacking magazine for receiving a stack of carton blanks, the stacking magazine including a retention system;
a first die comprising a first cavity for shaping the carton blanks; and
a transport device with a first gripping unit for gripping and displacing carton blanks, wherein the transport device is configured to grip a carton blank from the stack, to transport the carton blank into the first cavity and to form the carton blank by exerting a force.

2. The system according to claim 1, wherein the transport device is configured to grip the carton blank by suction and pull it into the first cavity.

3. The system according to claim 1, wherein the first die comprises a first passage opening, and the transport device is configured to move a portion of the first gripping unit through the first passage opening.

4. The system according to claim 1, wherein the transport device is configured to apply pressure to the carton blank from above and to press the carton blank into the first cavity.

5. The system according to claim 1 further comprising a second die for shaping carton blanks, the second die comprising an opening, wherein the transport device is configured to transport the carton blank from the stack through the second die into the first cavity.

6. The system according to claim 5, wherein the second die is arranged below the stacking magazine.

7. The system according to claim 5, wherein an upper opening width of the second die is greater than an upper opening width of the first cavity.

8. The system according to claim 5, wherein the first cavity is provided with a first bottom surface and side walls, the side walls of the first cavity having a first angle of inclination in relation to the first bottom surface, wherein the second die has inclined side walls, the inclined side walls of the second die having a second angle of inclination in relation to the opening which is smaller than the first angle of inclination.

9. A deep-drawing packaging machine or tray sealing machine comprising the system for destacking carton blanks according to claim 1.

10. A method for destacking carton blanks, comprising:
picking up a stack of carton blanks in a stacking magazine, the stacking magazine having a retention system;
providing a first die comprising a first cavity for shaping carton blanks;
gripping a carton blank by a transport device with a first gripping unit;
transporting the carton blank by the transport device from the stack into the first cavity; and
forming the carton blank in the first cavity while exerting a force on the carton blank by the transport device.

11. The method according to claim 10, wherein the carton blank is held from below by the first gripping unit through suction and drawn into the first cavity.

12. The method according to claim 10, wherein pressure is exerted on the carton blank from above by the first gripping unit and the carton blank is pressed into the first cavity.

13. The method according to claim 10, wherein the carton blank is transported from the stack first into a second die and then into the first cavity of the first die.

14. The method according to claim 13, wherein the second die is arranged below the stacking magazine.

15. The method according to claim 13, wherein an upper opening width of the second die is larger than an upper opening width of the first cavity.
